(19) United States
(12) Patent Application Publication
(10) Pub. No.: US 2004/0122887 A1
(43) Pub. Date: Jun. 24, 2004

(54) Efficient multiplication of small matrices using SIMD registers

(76) Inventor: William W. Macy, Palo Alto, CA (US)

Correspondence Address: Robert A. Burtzlaff, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/327,445

(22) Filed: Dec. 20, 2002

(51) Int. Cl. G06F 7/32

(52) U.S. Cl. 708/607

(57) ABSTRACT

An example of a matrix multiplication method that reduces calculation times on SIMD processors is described. The matrix multiplication requires loading each diagonal of the multiplicand matrix c into a different register of a processor, and loading a multiplier matrix a into at least one register in column order. Multiplication and addition elements in each column of multiplier matrix a in the register are selectively shifted to by shifting one element, with the last element of a column shifted to the front of the column. Diagonals of the multiplicand c matrix are multiplied by columns of the multiplier a matrix, with their product being added to the sum of products for columns of a result matrix.

### FIELD OF THE INVENTION

The present invention relates to matrix arithmetic. More particularly, the present invention provides examples of efficient multiplication of matrices using SIMD registers.

### BACKGROUND

Arithmetical manipulations of conventional m×n matrices is a common data processing task. A m×n matrix consists of m rows and n columns. Dimensions of multiplicand matrix c are n×m and multiplier matrix a are m×p. Resulting dimensions of b are n×p. Values in b are computed from the sum of products of values in rows in c by values in columns of a using the relation bᵢⱼ=Σₖ^{m}cᵢₖ*aₖⱼ where the first subscript refers to the row and the second to the column. Therefore, the value of an element in b in row i and column j is computed from the inner product of row i of C and column j of a. The total number of products m*n*p and the total number of additions is (m−1)*n*p.

For optimal results, matrix multiplication implementations have been used to execute the multiplications, additions, and data ordering steps with the minimum number of instructions. Since C is a matrix of coefficients and a is a matrix of data, various techniques have been developed that take advantage of the ability to pre-store elements of C in a fashion which is suitable for efficient implementation of matrix multiplication. However, this flexibility in storing elements is not available for data in matrix a. Data in a are generally stored in a logical order that is not aware of any data processing algorithm.

Matrix multiplication is used in applications such as coordinate and color transformations, imaging algorithms, and numerous scientific computing tasks. Matrix multiplication is a computationally intensive operation that can be performed with the assistance of Single Instruction, Multiple Data (SIMD) registers of microprocessors that support Conventional SIMD matrix multiplication proceeds by using SIMD instructions to arranges data and carry out matrix multiplication following the order of calculations indicated by the matrix multiplication equation:

bᵢⱼ=Σₖ^{m}cᵢₖ*aₖᵢ.

where:

b(x)=c(x)*a(x)

corresponds to

$$\begin{matrix}{b}_{0} & {b}_{0} & {b}_{0} & {b}_{0} \\ {b}_{1} & {b}_{1} & {b}_{1} & {b}_{1} \\ {b}_{2} & {b}_{2} & {b}_{2} & {b}_{2} \\ {b}_{3} & {b}_{3} & {b}_{3} & {b}_{3}\end{matrix} = \begin{matrix}{c}_{0} & {c}_{0} & {c}_{0} & {c}_{0} \\ {c}_{1} & {c}_{1} & {c}_{1} & {c}_{1} \\ {c}_{2} & {c}_{2} & {c}_{2} & {c}_{2} \\ {c}_{3} & {c}_{3} & {c}_{3} & {c}_{3}\end{matrix} * \begin{matrix}{a}_{0} & {a}_{0} & {a}_{0} & {a}_{0} \\ {a}_{1} & {a}_{1} & {a}_{1} & {a}_{1} \\ {a}_{2} & {a}_{2} & {a}_{2} & {a}_{2} \\ {a}_{3} & {a}_{3} & {a}_{3} & {a}_{3}\end{matrix}$$

Elements of result matrix b are computed from the inner product (dot product) of rows of the multiplicand matrix c by columns of multiplier matrix a. The first element of b is:

b₀₀=(c₀₀*a₀₀)+(c₀₁*a₁₀)+(c₀₂*a₂₀)+(c₀₃*a₃₀)

which is the product and sum of the first row of c and the first column of a.

Next:

b₀₁=(c₀₀*a₀₁)+(c₀₁*a₁₁)+(c₀₂*a₂₁)+(c₀₃*a₃₁)

is the product and sum of the first tow of c again and the second column of a. The calculation continues until results for the first row are complete. The next row of b is computed using the next row of c starting with:

b₀₀=(c₁₀*a₀₀)+(c₁₁*a₁₀)+(c₁₂*a₂₀)+(c₁₃*a₃₀).

With appropriate changes (XOR instead of addition), the same pattern is used for modular multiplication and conventional multiplication.

The conventional implementation of matrix multiplication using SIMD instructions stores elements of multiplier matrix, a, in SIMD register(s) in the order they are stored in memory and stores elements of the multiplicand matrix, c , in SIMD registers in row order repeating the rows by the number of columns in c. Elements of a are stored in the register in the order they are stored in memory. For example, in a 4 column matrix elements of the first row in c are repeated 4 times because there are 4 columns of c. If the size of c were smaller than the SIMD register, elements from other tows of c could also be stored in the SIMD register. If the size of C were larger than the SIMD register, additional registers would be required to store data from the row.

Matrix multiplication of results using the data stored in SIMD registers begins by multiplying elements in C by elements in a−c₀₀*a₀₀, c₀₁*a₁₀, . . . c₀₃*a₃₃. Next, sums of these products for each row, which are adjacent to each other in the same register, must be computed. If a multiply-accumulate (MAC) instruction is used some of these sums of products are computed when the multiplications computed. Typically b₀₀ is computed, followed by computation of b₀₁. The register with values of c is loaded with the next row of matrix c to compute elements of the next row of matrix b.

While accurate, in operation significant data reordering of modular products may be required so that they can compute elements of b (with XOR providing, for example, an addition operation in a Galois field arithmetic operation). Also, results must be exchanged between registers before they can be stored if the results do not fit in one register. Both problems result in significant computational overhead that impacts speed of matrix multiplication processing.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 schematically illustrates a computing system supporting SIMD registers;

FIG. 2 is a procedure for reordering data for efficient matrix multiplication;

FIG. 3 illustrates a genetic 4×4 modular matrix multiplication;

FIG. 4 illustrates reordering of data for register based multiplication;

FIG. 5 illustrates the registers after reordering according to FIG. 4;

FIG. 6 illustrates matrix multiplication after reordering according to FIGS. 4 and 5;

FIG. 7 illustrates modular matrix multiplication where the number of elements in a diagonal of the multiplicand matrix, c, is not equal to the number of elements in a column of the multiplier matrix;

FIG. 8 illustrates reordering of data for register based multiplication;

FIG. 9 illustrates matrix multiplication after reordering according to FIGS. 7 and 8;

FIG. 10 illustrates modular matrix multiplication where multiplicand matrix c diagonal is less than multiplier matrix a using a 2×3 column c and a 3×4 matrix;

FIG. 11 illustrates reordering of data for register based multiplication;

FIG. 12 illustrates matrix multiplication after reordering according to FIG. 10 and 11;

FIG. 13 illustrates modular matrix multiplication with regular matrices;

FIG. 14 illustrates reordering of data for register based multiplication; and

FIG. 15 illustrates matrix multiplication after reordering according to FIGS. 13 and 14.

### DETAILED DESCRIPTION

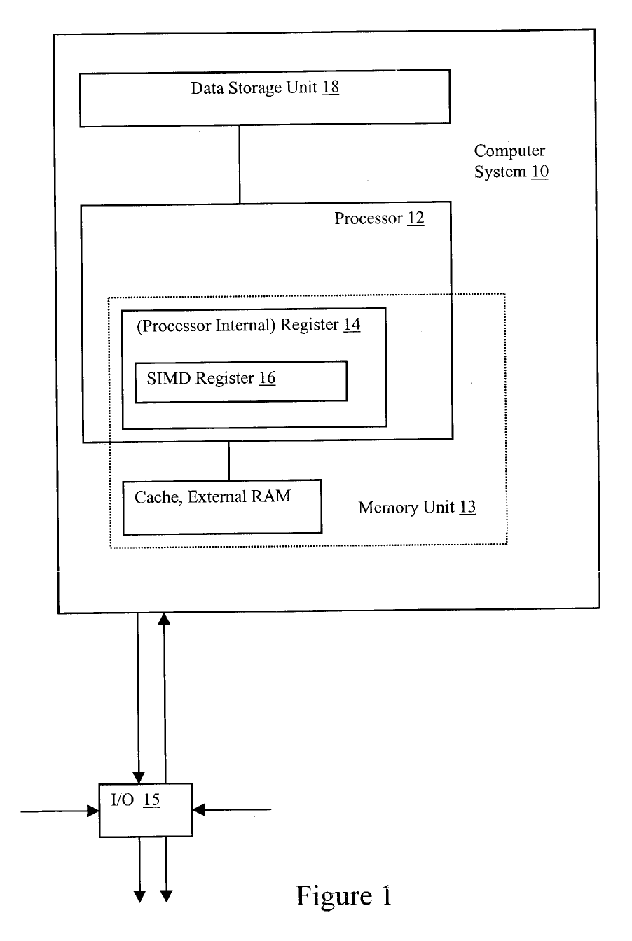

FIG. 1 generally illustrates a computing system 10 having a processor 12 and memory system 13 (which can be any accessible memory, including external cache memory, external RAM, and/or memory partially internal to the processor) for executing instructions that can be externally provided in software as a computer program product and stored in data storage unit 18.

The processor 12 of computing system 10 also supports internal memory registers 14, including Single Instruction, Multiple Data (SIMD) registers 16. Registers 14 are not limited in meaning to a particular type of memory circuit. Rather, a register of an embodiment requires the capability of storing and providing data, and performing the functions described herein. In one embodiment, the register 14 includes multimedia registers, for example, SIMD registers 16 for storing multimedia information. In one embodiment, multimedia registers each store up to one hundred twenty-eight bits of packed data. Multimedia registers may be dedicated multimedia registers or registers which are used for storing multimedia information and other information. In one embodiment, multimedia registers store multimedia data when performing multimedia operations and store floating point data when performing floating point operations.

The computer system 10 of the present invention may include one or more I/O (input/output) devices 15, including a display device such as a monitor. The I/O devices may also include an input device such as a keyboard, and a cursor control such as a mouse, trackball, or trackpad. In addition, the I/O devices may also include a network connector such that computer system 10 is part of a local area network (LAN) or a wide area network (WAN), the I/O devices 15, a device for sound recording, and/or playback, such as an audio digitizer coupled to a microphone for recording voice input for speech recognition. The I/O devices 15 may also include a video digitizing device that can be used to capture video images, a hard copy device such as a printer, and a CD-ROM device.

In one embodiment, a computer program product readable by the data storage unit 18 may include a machine or computer-readable medium having stored thereon instructions which may be used to program (i.e. define operation of) a computer (or other electronic devices) to perform a process according to the present invention. The computer-readable medium of data storage unit 18 may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

Computing system 10 can be a general-purpose computer having a processor with a suitable register structure, or can be configured for special purpose or embedded applications. In an embodiment, the methods of the present invention are embodied in machine-executable instructions directed to control operation of the computing system, and more specifically, operation of the processor and registers. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression.

Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

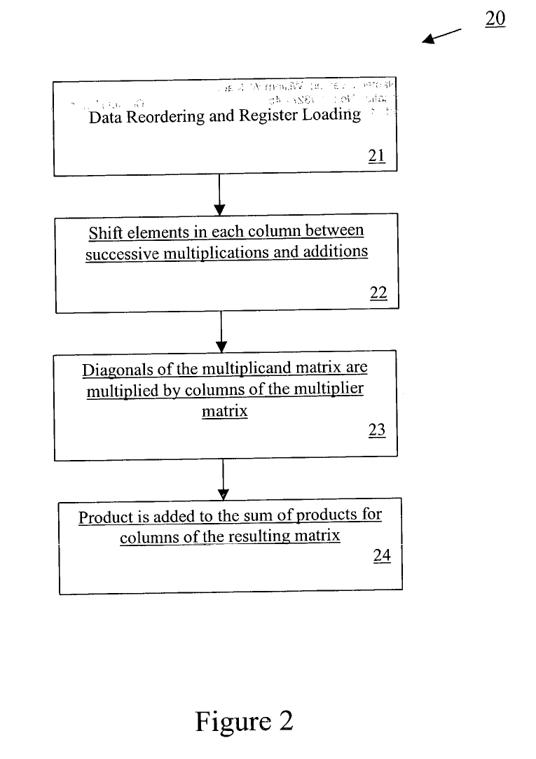

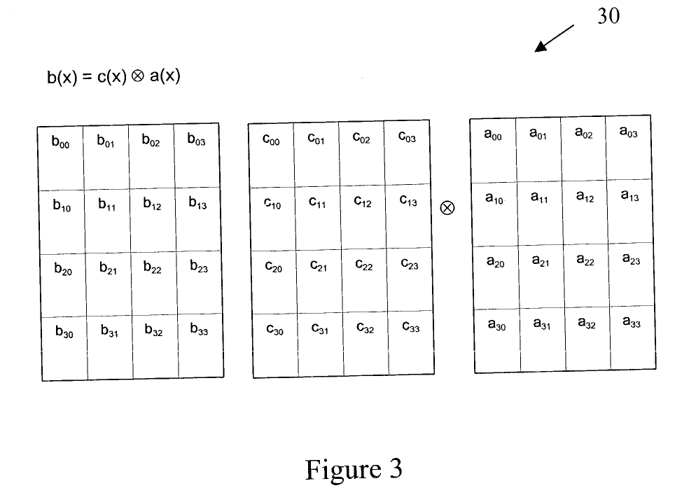

FIGS. 2 presents one embodiment of an procedure for multiplication of a matrix such as illustrated in FIG. 3 according to the present invention. As seen in FIG. 2, data is first organized by reordering and loading in memory (in this example, registers labeled as box 21) for efficient matrix multiplication. Each diagonal of the multiplicand matrix, c, is loaded into a different register. Those diagonals with an element in the right most column that is not in the bottom row is extended to the element in the next row using a copy of the matrix positioned adjacent to the right column. The next element of a diagonal is in the next row. The diagonals are duplicated in register(s) a number of times equal to the number of columns in the multiplier matrix, a. The number of elements in a diagonal is equal to the number of columns in c. Data of the multiplier matrix, a, is loaded into registers(s) in column order, the order data is stored in memory. Between each multiplication and addition elements in each column of a in the register are shifted one element (box 22). The last element of a column is shifted or rotated to the front of the column. Diagonals of the multiplicand c matrix are multiplied by columns of the multiplier a matrix (that may have been adjusted in length) (box 23) and their product is added to the sum of products for columns of the result matrix, b (box 24).

If the number of elements of a column of a is different from the number of a column of c, the number of elements from a column of a in the SIMD register is adjusted to equal the number of elements in a column of c. One way of determining which elements of multiplier matrix a to select is first stack copies of multiplier matrix a on top of each other so columns are aligned and so that the top row of a copy is below the bottom row and other copy. This effectively extends each column. Since the number of elements taken from an extended column is equal to the number of elements in a diagonal of the multiplicand matrix c. Following each multiply and add operation elements are selected for the next multiply and add operation by shifting the down the extended column an element. If the length of a multiplicand diagonal is greater than a multiplier column then equal values will be selected from a column, and if the length of a multiplicand diagonal is less than a multiplier column then not all values from a column will be selected.

While the foregoing example employs internal processor registers, it will be understood that it is not always necessary to load an internal processor register to perform the SIMD operation. Operands used for multiplication or other can be stored in memory instead of being first loaded into a register. Certain architectures such as RISC architectures load registers first, but the Intel Architecture can have operands that are in memory. A comparison of use of register and memory operands is

pmaddwd xmm0, xmm1

and

pmaddwd xmm0, [eax]

These produce the same result in xmm0 if data stored stored in address that is in register eax is the same as data in xmm1. It is desirable to use the memory operand if the code. runs out of registers and the memory access is fast.

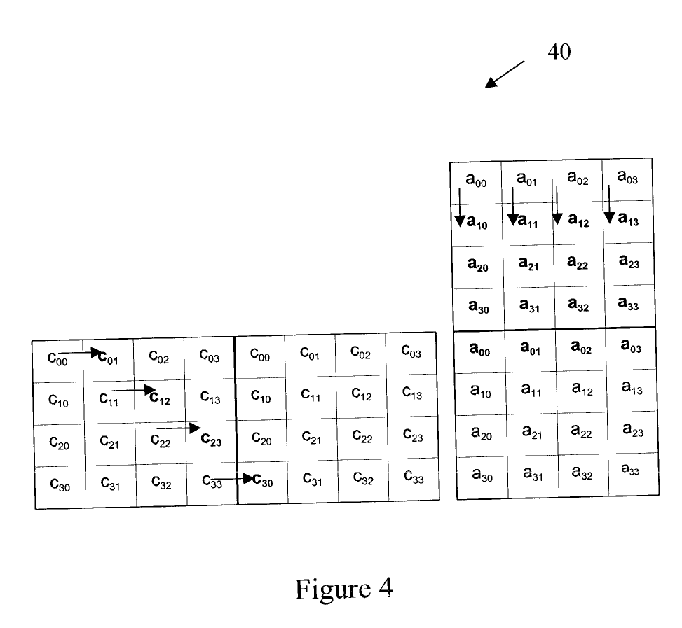

FIG. 3 shows modular multiplication 30 in accordance with the procedure generally discussed with respect to FIG. 2. In this example, the modular multiplication is a Galois field arithmetic where XOR is used to add values without carries (e.g. binary addition without carries such that 1+1=0, 0+0=0, 0+1=1 and 1+0=1, and with results ordinarily being calculated by an XOR). As seen in FIG. 3, multiplication 30 of regular square matrices b(x)=c(x)\mathring{x}a(x) is determined. FIG. 4 illustrates determination of a register data loading pattern 40 for multiplication of the matrices illustrated in FIG. 3. As seen in an register ordering schematic 40 of FIG. 4, data in registers for the next step are in bold type. Solid lines indicate boundaries where the matrix is duplicated. In a first step columns of a are multiplied by a diagonal of c. The second step, columns of a are shifted and multiplied by the next diagonal of c as indicated by the arrows.

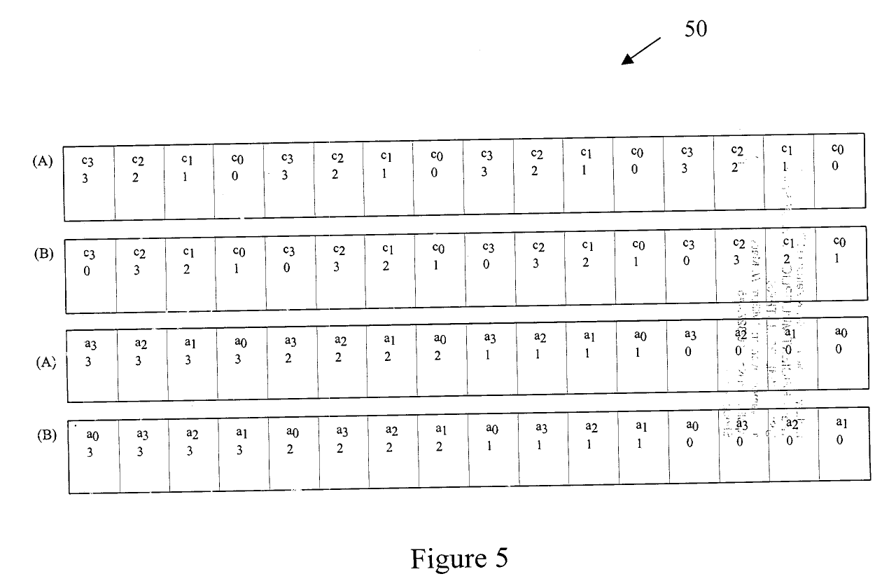

FIG. 5 illustrates the order 50 of data in registers resulting from the shifts indicated in FIG. 4. As seen with respect to timestep (A) in FIG. 5, the registers hold the main diagonal of c, and data of the a matrix in the order it is stored in memory. In timestep (B) of FIG. 5 the registers hold the diagonal and columns of a shifted. Shifting columns is implemented by rotating elements using a byte shuffle operation. Note that columns in a can be shifted up and selection diagonals in c can be selected to the left instead of the right.

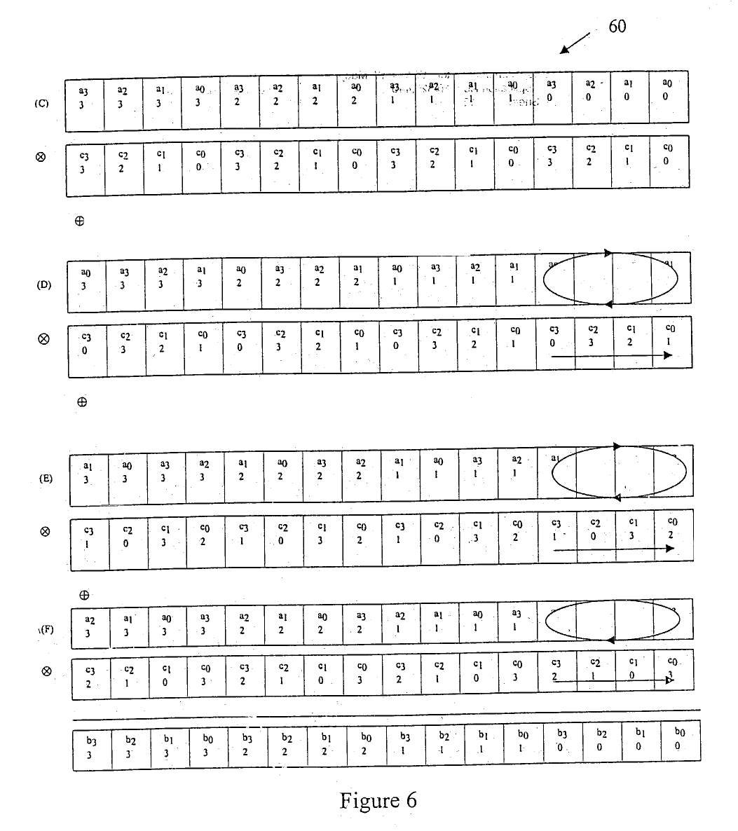

FIG. 6 further illustrates operations 60 for multiplying 4×4 matrices a and c. Data for each timestep are ordered as described above in relation to FIGS. 4 and 5. At each timestep C, D, E, and F the modular product of a and c are computed. Products are added with XOR to products of other steps.

The following pseudocode snippet provides a sample implementation of matrix multiplication:

| | | |
|---|---|---|
| (1) | LOAD R3, MEMORY | ;c matrix diagonal 1 |
| (2) | LOAD R4, MEMORY | ;c matrix diagonal 2 |
| (3) | LOAD R5, MEMORY | ;c matrix diagonal 3 |
| (4) | LOAD R6, MEMORY | ;c matrix diagonal 4 |
| (5) | LOAD R7, MEMORY | ;data shuffle pattern |
| (6) | LOAD R0, MEMORY | ;load a data from memory (first |
| | | pattern) |
| (7) | MOVE R1, R0 | ;copy first data pattern |
| (8) | MODMUL R0, R3 | ;multiply a data by diagonal 1 |
| | | (main diagonal) |

| | | |
|---|---|---|
| (9) | SHUFFLE R1, R7 | ;produce second a data pattern |
| | | rotating columns |

| | | |
|---|---|---|
| (10) | MOVE R2, R1 | ;copy second a data pattern |

| | | |
|---|---|---|
| (11) | MODMUL R1, R4 | ;multiply second a data pattern by |
| | | diagonal 2 |
| (12) | XOR R0, R1 | ;add second pattern to first |
| (13) | SHUFFLE R2, R7 | ;produce third a data pattern rotating |
| | | columns |

| | | |
|---|---|---|
| (14) | MOVE R1, R2 | ;copy third data pattern |

| | | |
|---|---|---|
| (15) | MODMUL R2, R5 | ;multiply third a data pattern by |
| | | diagonal 3 |
| (16) | XOR R0, R2 | ;add third pattern |
| (17) | SHUFFLE R1, R7 | ;produce fourth a data pattern rotating |
| | | columns |
| (18) | MODMUL R1, R6 | ;multiply fourth data pattern by |
| | | diagonal 4 |
| (19) | XOR R0, R1 | ;add fourth pattern |

| | | |
|---|---|---|
| (20) | STORE MEMORY, R0 | ;store output matrix |

Instructions 9 through 12 represent the basic operations of this method. Columns of the multiplier a matrix are rotated in instruction 9. The result is copied in instruction 10 because it is overwritten by the multiplication in instruction 11, and the product is added to the sum of products in instruction 12.

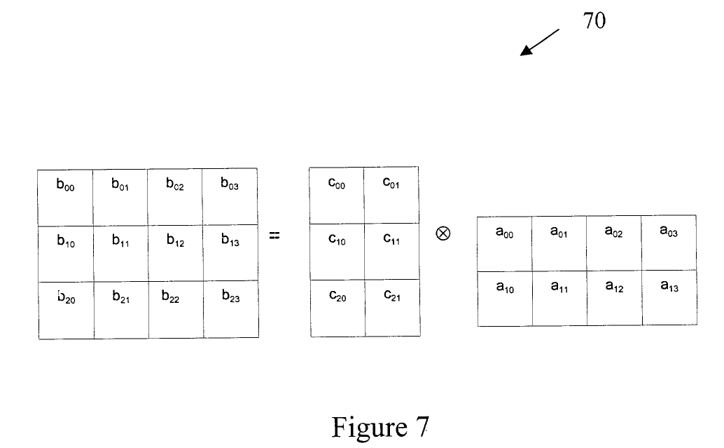

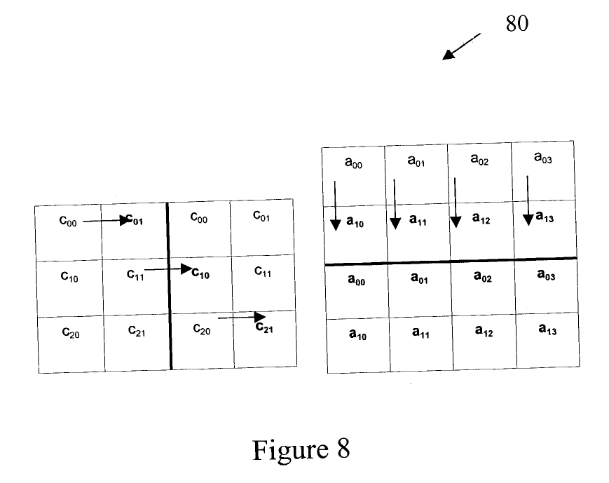

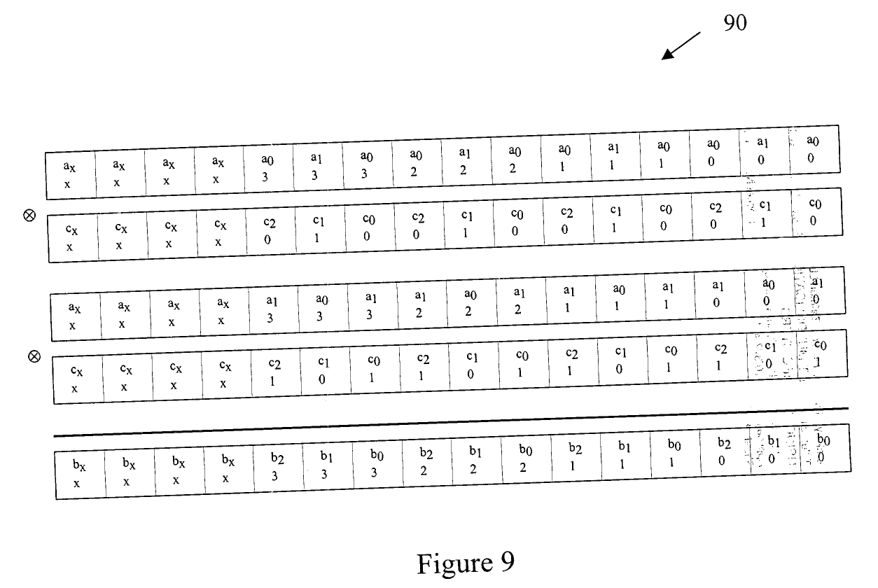

Non-regular matrices can also be subject to an embodiment of the procedure of the invention. For example, consider the matrix multiplication 70 of FIG. 7, where the number of elements in a diagonal of the multiplicand matrix, c, is not equal to the number of elements in a column of the multiplier matrix, a and the multiplicand matrix c diagonal greater than multiplier matrix a column. In this example, modular multiplication of a 3×2, c, matrix by a 2×4 matrix, a. The method for selecting and ordering data in SIMD registers for this example is described in FIG. 8. The first diagonal of c is c₀₀, c₁₁, c₂₀. This diagonal is multiplied by the first 3 values of extended columns of a. Since the column length of a is only 2, a matrices are stacked on each other in an order 80 as shown in FIG. 8 to effectively extend the length of columns. Another way of looking at this is once the end of a column is reached in wraps or rotates back the first value. FIG. 9 shows data arrangement 90 of values for the first diagonal of c and the extended columns of a. Note that the first 3 values of a on the right are a₀₀, a₁₀, a₀₀ so a₀₀ is repeated. The next diagonal of c is is c₀₁, c₁₀, c₂₁ and next column of a is a₁₀, a₀₀, a₁₀ which is selected by shifting down one element in each extended column as shown in FIG. 8. FIG. 9 further illustrates operations for multiplying matrices a and C. Data order 90 for each timestep is as described above in relation to FIGS. 7 and 8. At each timestep the modular product of a and c are computed. Products are added with XOR to products of other steps.

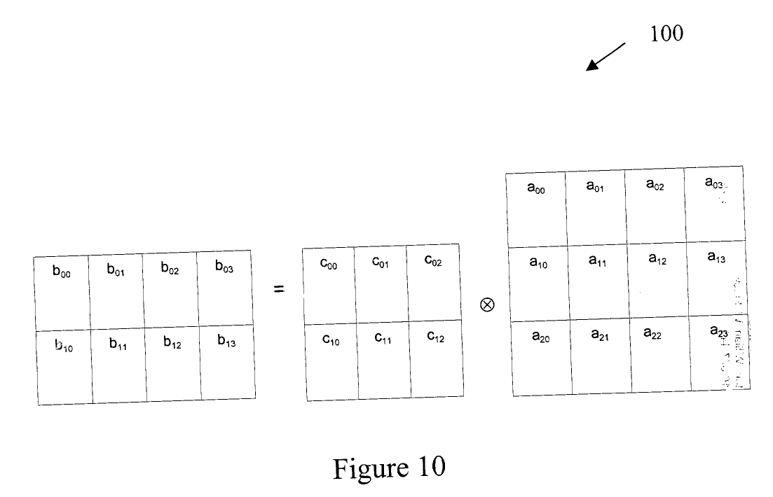

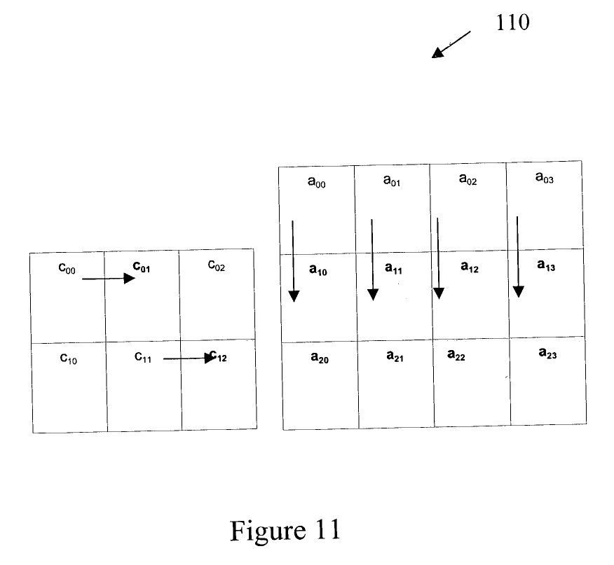

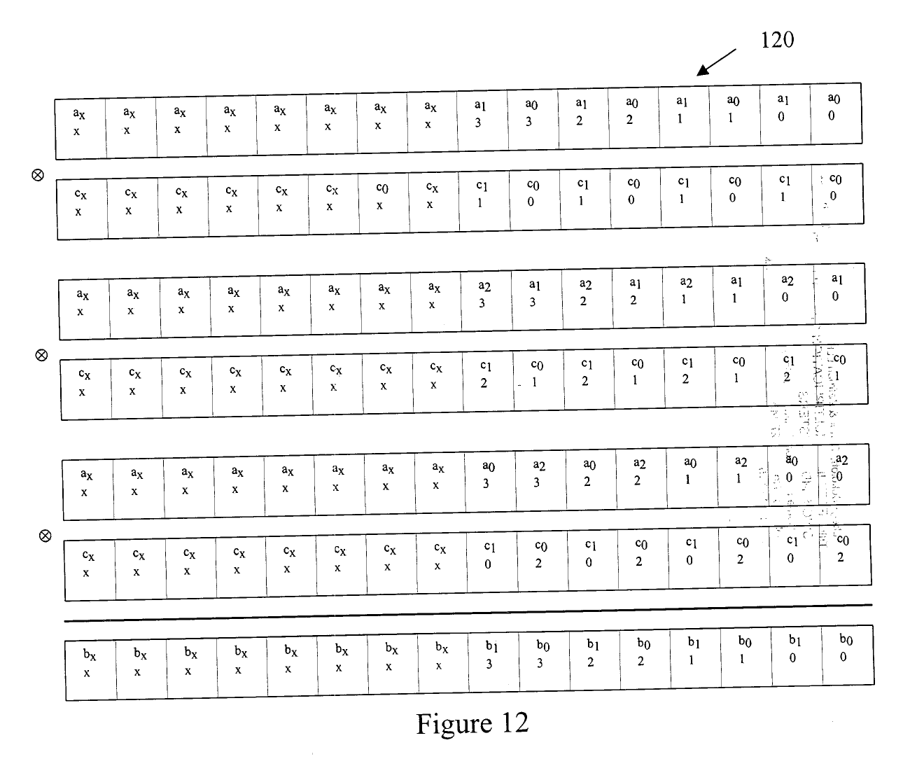

FIG. 10 shows modular multiplication 100 with multiplicand matrix c diagonal less than multiplier matrix a using 2×3 column c and a 3×4 matrix, a. As seen in FIG. 11, order selection 110 sets the first diagonal of c as c₀₀ and c₁₁. This diagonal is multiplied by the first 2 values of extended columns of a, a₀₀ and a₁₀. Column length of a is length 3, but only 2 values of column a are selected. FIG. 12 shows data arrangement 120 of values in registers. There are three pairs of registers with values from matrices a and c which are multiplied together because matrix c has 3 diagonals. Only the first 2 values of a of the first column a₀₀ and a₁₀ are stored in the first register. In the next pair of registers the diagonal of c is c₀₁ and c₁₂ and next values of from a are selected by shifting down. For example, values in from the first column are a₁₀ and a₂₀. The third pair of registers holds the third diagonal and the next values shifting down columns of a. In this case values from the first column are a₂₀ and ao₀.

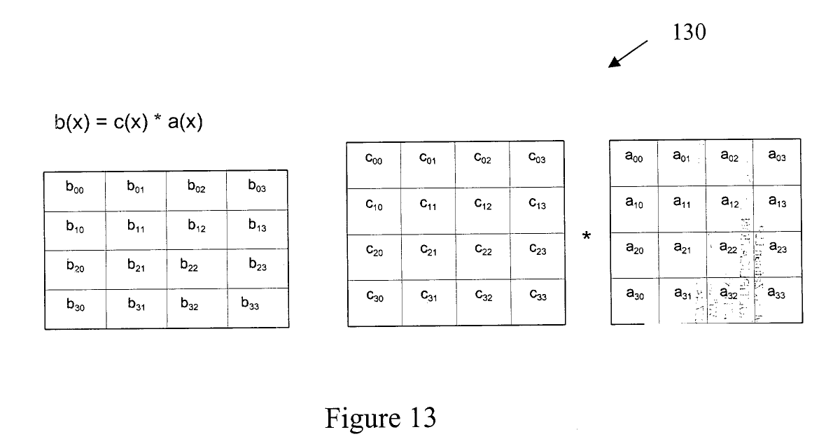

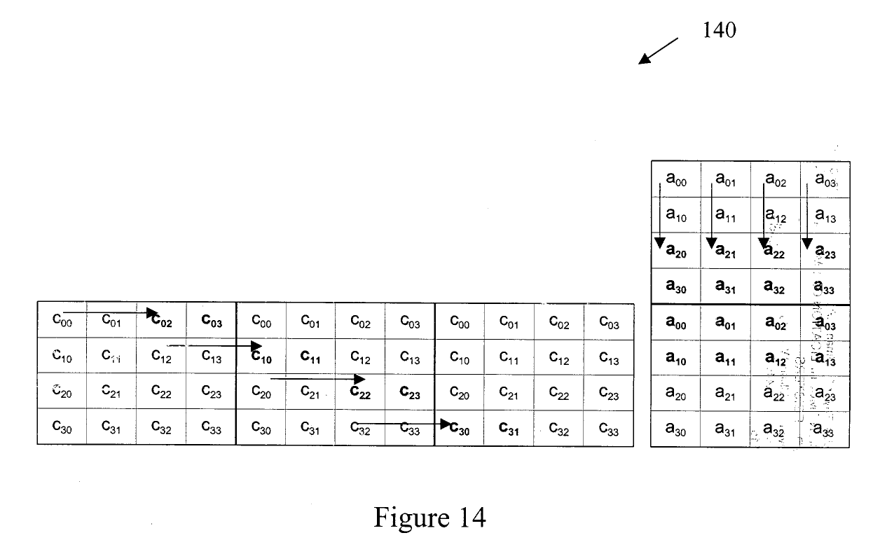

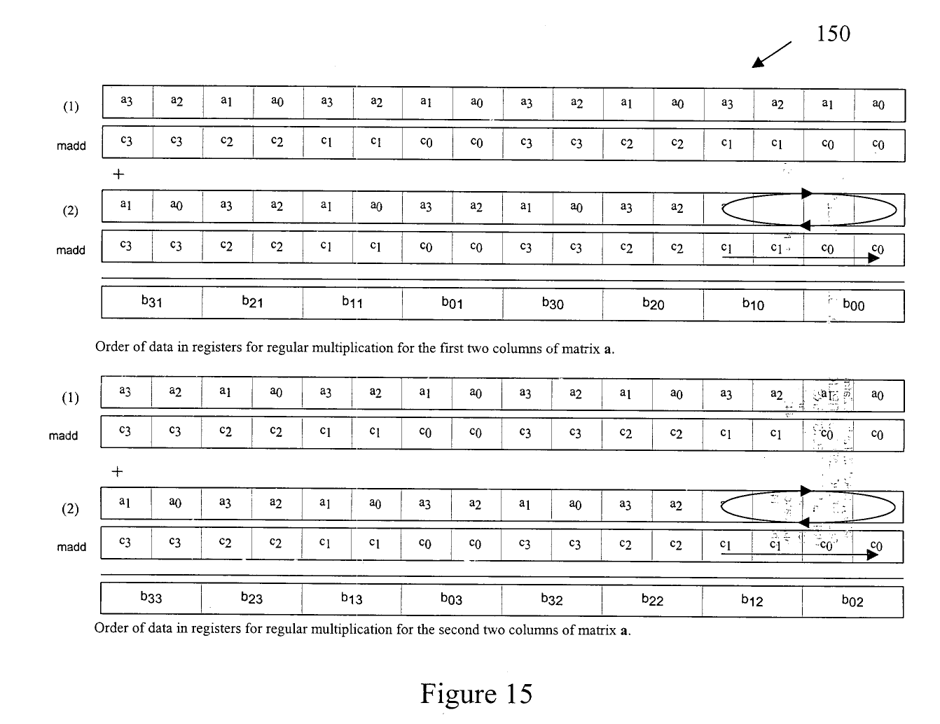

As will be understood, the foregoing description of FIGS. 3-12 describe arithmetic operations that do not require a multiply/accumulate (MAC) instruction. Instead, Galois field arithmetic using modular multiplication and XOR for addition is described. If the sum of products of elements of a row of the multiplicand and a column the multiplier are represented by the same data type as the original matrix elements then the only difference between conventional arithmetic and Galois field arithmetic is the method used for addition and multiplication. All of the patterns remain the same. If the data type required by the result is greater in size than that of the original data then the data type of the matrix elements is increased—generally doubling the size—before matrix multiplication. In this case the constant multiplicand matrix data is stored as the larger data type. For example, byte sized coefficients are stored as 16-bit integers. The data type of the multiplier matrix is changed before the calculations shown in FIGS. 3-12. The SIMD unpack operation is generally used to change the data type. This will increase then number of registers required, but otherwise the operations described in FIGS. 3-12 are invariant with respect to Galois field or conventional arithmetic. If a MAC instruction is available, matrix multiplication can proceed as shown with respect to the following FIGS. 13-15. While a MAC instruction can be used for any form of arithmetic (including Galois field arithmetic), in the case of conventional fixed point arithmetic a MAC computes 2 products, adds these products and generally writes the result as a data type that is twice the size of the original multiplicand and multiplier (byte to 16-bit word and 16-bit word to double 32-bit word are typical). In the case of a Galois field arithmetic a MAC computes 2 products using modular multiplication, adds the products using an XOR operation, and writes a result which is the same data type. The number of bits required to represent a sum or product in Galois field arithmetic is the same as the number of bits in the required to represent the original data. MACs for conventional arithmetic are found in most all SIMD instruction sets (i.e. madd in an Intel Architecture Instruction Set)Accordingly, FIG. 13 shows multiplication 130 with regular matrices and use of a suitable MAC instruction. As seen in FIG. 14, ordering 140 indicates data in registers for the successive step in bold type. Solid lines indicate boundaries where the matrix is duplicated. Note that for regular matrix multiplication elements are two values and each shift is two values. In the regular multiplication case there are twice the number of values in a c matrix diagonal as an a matrix column as shown in FIG. 14 (8 values ordered in this example). Each a matrix column is duplicated as shown in the register ordering 150 of FIGS. 15a and b. Consequently, the first two columns of the a matrix are held in one register and the second two are held in another. The approach to ordering data for regular matrix multiplication is the same as that for modular multiplication except in the regular case elements are two values, the shift to the data order of the next step is two values, and multiplier columns are duplicated. A multiply-add operation is applied to adjacent values in a and c. This operation multiplies values in a and c and adds adjacent products. Multiply-add results are stored in spaces twice the size of the initial data. For example, in step (1) the madd operation computes the product of a₀₀ and c₀₀ and the product of a₁₀ and c₀₁ and adds the two products. Similarly, in step (2) the madd operation computes the product of a₂₀ and c₀₂ and the product of a₃₀ and c₀₃ and adds the two products. Results of the madd operations are added to give the result for matrix multiplication, b₀₀.

Pseudocode for regular matrix multiplication using 16 bit words and 128 bit registers is illustrated as follows:

| | | |
|---|---|---|
| (1) | LOAD R5, MEMORY | ;coefficient diagonal 1 |
| (2) | LOAD R6, MEMORY | ;coefficient diagonal 2 |
| (3) | LOAD R7, MEMORY | ;data shuffle pattern |
| (4) | LOAD R0, MEMORY | ;load data from memory |

(first pattern)

| | | |
|---|---|---|
| (5) | MOVE R2, R0 | ;copy first data pattern |
| (6) | UNPACKLDQ R0, R0 | ;duplicate data columns 1&2 |
| (7) | MOVE R1, R0 | ;copy cols 1&2 |
| (8) | MADD R0, R5 | ;multiply accumulate 1&2 |

| | | |
|---|---|---|
| (9) | SHUFFLE R1, R7 | ;produce second data pattern |

| | | |
|---|---|---|
| (10) | MADD R1, R6 | ;multiply accumulate pattern |

2 cols 1&2

| | | |
|---|---|---|
| (11) | ADDW R0, R1 | ;result cols 1&2 |
| (12) | STORE MEMORY, R0 | ;store result cols 1&2 |
| (13) | UNPACKHDQ R2, R2 | ;duplicate cols 3&4 |
| (14) | MOVE R3, R2 | ;copy cols 3&4 |
| (15) | MADD R2, R5 | ;multiply accumulate cols |

3&4

| | | |
|---|---|---|
| (16) | SHUFFLE R3, R7 | ;produce second data pattern |

| | | |
|---|---|---|
| (17) | MADD R3, R6 | ;multiply accumulate pattern |

2 cols 3&4

| | | |
|---|---|---|
| (18) | ADDW R2, R3 | ;result cols 3&4 |
| (19) | STORE MEMORY, R2 | ;store result cols 3&4 |

Each result is produced by two multiply-add operations, one shuffle, and one addition of the multiply-add results. Results are 16-bits so the 16 results require two 128-bit registers

While this invention is particularly useful for multiplication of matrices of byte data implemented with SIMD instructions the invention is not restricted to such multiplications. Larger data types can be used, only requiring reduction in the number of elements that can be stored in a register, and larger matrices have more elements that must be stored. If diagonals of the multiplicand matrix, c, or the columns of the multiplier matrix, a, do not fit in a SIMD register they can be extended to additional registers. In some cases for using larger registers the rotation of data in a column may require exchanging elements between registers.

As will be understood, reference in this specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” ate not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Accordingly, it is the following claims, including any amendments thereto, that define the scope of the invention.

The claimed invention is:

1. A matrix multiplication method, comprising:
loading each diagonal of the multiplicand matrix c into processor accessible memory,
loading a multiplier matrix a into processor accessible memory in column order,
shifting elements in each column of multiplier matrix a in the register by shifting one element, with the last element of a column shifted to the front of the column, and
multiplying diagonals of the multiplicand c matrix by columns of the multiplier a matrix, with their product being added to the sum of products for columns of a result matrix.

2. The method according to claim 1, wherein the processor accessible memory is a SIMD register.

3. The method according to claim 2, further comprising loading a diagonal into multiple SIMD registers of the processor.

4. The method according to claim 1, wherein the multiplier a matrix is adjusted in length prior to multiplying with diagonals of the multiplicand c matrix by stacking copies of multiplier matrix a on top of each other so columns are aligned and a top row of a copy is below a bottom row and any other copy to extend each column.

5. The method according to claim 1, wherein the multiplicand matrix C diagonal is shorter than multiplier matrix a column.

6. The method according to claim 1, wherein the multiplicand matrix C diagonal is longer than multiplier matrix a column.

7. The method according to claim 1, wherein shifting the elements further comprises multiplying columns of a by a diagonal of c; and shifting and multiplying columns of a by a next diagonal of c in a predetermined order

8. The method according to claim 1, wherein shifting the elements further comprises rotating elements using a byte shuffle operation.

9. The method according to claim 1, wherein each element is a byte.

10. The method according to claim 1, wherein multiplying diagonals further comprises application of a MAC operation.

11. An article comprising a storage medium having stored thereon instructions that when executed by a machine result in:
loading each diagonal of the multiplicand matrix c into processor accessible memory,
loading a multiplier matrix a into processor accessible memory in column order,
shifting the elements in each column of multiplier matrix a in the register by shifting one element, with the last element of a column shifted to the front of the column, and
multiplying diagonals of the multiplicand c matrix by columns of the multiplier a matrix, with their product being added to the sum of products for columns of a result matrix.

12. The article comprising a storage medium having stored thereon instructions of claim 11, wherein the processor accessible memory is a SIMD register.

13. The article comprising a storage medium having stored thereon instructions of claim 12, wherein a diagonal is loaded into multiple SIMD registers of the processor

14. The article comprising a storage medium having stored thereon instructions of claim 11, wherein the multiplier a matrix is adjusted in length prior to multiplying with diagonals of the multiplicand c matrix by stacking copies of multiplier matrix a on top of each other so columns are aligned and a top row of a copy is below a bottom row and any other copy to extend each column.

15. The article comprising a storage medium having stored thereon instructions of claim 11, wherein the multiplicand matrix c diagonal is shorter than multiplier matrix a column.

16. The article comprising a storage medium having stored thereon instructions of claim 11, wherein the multiplicand matrix c diagonal is longer than multiplier matrix a column.

17. The article comprising a storage medium having stored thereon instructions of claim 11, wherein shifting the multiplication and addition elements further comprises multiplying columns of a by a diagonal of c; and shifting and multiplying columns of a by a next diagonal of c in a predetermined order

18. The article comprising a storage medium having stored thereon instructions of claim 11, wherein shifting the multiplication and addition elements further comprises rotating elements using a byte shuffle operation.

19. The article comprising a storage medium having stored thereon instructions of claim 11, wherein multiplying diagonals further comprises application of a MAC operation.

20. The article comprising a storage medium having stored thereon instructions of claim 11, wherein each element is a byte.

21. A system comprising
a processor having registers that load each diagonal of the multiplicand matrix c into processor accessible memory, with a multiplier matrix a loaded into processor accessible memory in column order, and
control logic to shift the multiplication and addition elements in each column of multiplier matrix a in the registers by shifting one element, with the last element of a column shifted to the front of the column, and multiply diagonals of the multiplicand c matrix by columns of the multiplier a matrix, with their product being added to the sum of products for columns of a result matrix.

22. The system according to claim 21, wherein the processor accessible memory is a SIMD register.

23. The system according to claim 22, further comprising loading a diagonal into multiple SIMD registers of the processor.

24. The system according to claim 21, wherein the multiplier a matrix is adjusted in length prior to multiplying with diagonals of the multiplicand c matrix by stacking copies of multiplier matrix a on top of each other so columns are aligned and a top row of a copy is below a bottom row and any other copy to extend each column.

25. The system according to claim 21, wherein the multiplicand matrix c diagonal is shorter than multiplier matrix a column.

26. The system according to claim 21, wherein the multiplicand matrix c diagonal is longer than multiplier matrix a column.

27. The system according to claim 21, wherein control logic to shift the multiplication and additional elements further comprises multiplying columns of a by a diagonal of c; and shifting and multiplying columns of a by a next diagonal of c in a predetermined order

28. The system according to claim 21, wherein control logic to shift the multiplication and addition elements further comprises rotating elements using a byte shuffle operation.

29. The system according to claim 21, wherein each element is a byte.

30. The system according to claim 21, wherein multiplying diagonals further comprises application of a MAC operation.
